(19) United States
(12) Patent Application Publication
(10) Pub. No.: US 2026/0143167 A1
(43) Pub. Date: May 21, 2026

(54) METHOD FOR ENCODING IMAGE INFORMATION, METHOD FOR DECODING IMAGE INFORMATION, COMPUTER-READABLE STORAGE MEDIUM, AND METHOD FOR TRANSMITTING IMAGE INFORMATION

(71) Applicant: LG Electronics Inc., Seoul (KR)

(72) Inventors: Hendry TAN, Seoul (KR); Junghak NAM, Seoul (KR); Jaehyun LIM, Seoul (KR); Seunghwan KIM, Seoul (KR)

(21) Appl. No.: 19/442,354

(22) Filed: Jan. 7, 2026

Related U.S. Application Data
(63) Continuation of application No. PCT/KR2025/005322, filed on Apr. 18, 2025.
(60) Provisional application No. 63/636,107, filed on Apr. 19, 2024.

(51) Int. Cl. H04N 19/70; H04N 19/187

(52) U.S. Cl. CPC H04N 19/70; H04N 19/187

(57) ABSTRACT

According to an embodiment of the present disclosure, a method for decoding image information includes obtaining the image information including at least one primary picture layer among a plurality of layers and at least one object mask information (OMI) related message associated with the at least one primary picture layer, respectively; and processing the at least one OMI related message. An OMI related message among the at least one OMI related message is associated with only a current primary picture layer among the at least one primary picture layer.

### CROSS-REFERENCE TO RELATED APPLICATIONS

This application is a Bypass Continuation Application of International Application No. PCT/KR2025/005322, filed on Apr. 18, 2025, which claims priority from U.S. Provisional Application No. 63/636,107, filed on Apr. 19, 2024, the disclosures of which are incorporated by reference in their entireties.

### BACKGROUND

### 1. Field

The present disclosure relates to a method of decoding image information, a method of encoding image information, a computer-readable storage medium for storing information, and/or a method of transmitting a bitstream of image information.

### 2. Description of the Related Art

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### SUMMARY

Therefore, it is an aspect of the present disclosure to provide an encoding/decoding method and/or apparatus with improved coding efficiency.

It is another aspect of the present disclosure to provide an encoding/decoding method and/or apparatus with improved data transmission efficiency.

It is another aspect of the present disclosure to provide an encoding/decoding method and/or apparatus that may reduce power consumption of a decoding apparatus and improve accuracy of image analysis.

Technical objects to be achieved in the present disclosure are not limited to those described above, and other technical objects that have not been described above will be clearly understood by those skilled in the technical field to which the present disclosure pertains from the following description.

According to an embodiment of the present disclosure, a method for decoding image information includes obtaining the image information including at least one primary picture layer among a plurality of layers and at least one object mask information (OMI) related message associated with the at least one primary picture layer, respectively; and processing the at least one OMI related message. An OMI related message among the at least one OMI related message is associated with only a current primary picture layer among the at least one primary picture layer.

According to an embodiment of the present disclosure, an apparatus for decoding information includes a memory and at least one processor coupled to the memory. The at least one processor is configured to obtain the image information including at least one primary picture layer among a plurality of layers and at least one object mask information (OMI) related message associated with the at least one primary picture layer, respectively; and process the at least one OMI related message. An OMI related message among the at least one OMI related message is associated with only a current primary picture layer among the at least one primary picture layer.

According to the embodiment of the present disclosure, in the method or the apparatus for decoding image information, the OMI related information may be present in the current primary picture layer.

According to the embodiment of the present disclosure, in the method or the apparatus for decoding image information, the image information may further include at least one auxiliary picture layer associated with the current primary picture layer. The OMI related message may include information on the at least one auxiliary picture layer.

According to the embodiment of the present disclosure, in the method or the apparatus for decoding image information, the information on the at least one auxiliary picture layer may include information on an object mask of the at least one auxiliary picture layer.

According to the embodiment of the present disclosure, in the method or the apparatus for decoding image information, the OMI related information may further include OMI persistence flag information indicating persistence of the object mask information of the OMI related information. Object mask information of the OMI related information may be applied only for a current picture based on a value of the OMI persistence flag information equal to 0. The object mask information of the OMI related information may be applied for the current picture and subsequent pictures in the current primary picture layer based on a value of the OMI persistence flag information equal to 1.

According to an embodiment of the present disclosure, a method for encoding image information includes generating at least one object mask information (OMI) related message associated with at least one primary picture layer among a plurality of layers, respectively; and encoding the image information including the OMI related message. An OMI related message among the at least one OMI related message is associated with only current primary picture layer among the at least one primary picture layer.

According to an embodiment of the present disclosure, an apparatus for decoding information includes a memory and at least one processor coupled to the memory. The at least one processor is configured to generate at least one object mask information (OMI) related message associated with at least one primary picture layer among a plurality of layers, respectively; and encode the image information including the OMI related message. An OMI related message among the at least one OMI related message is associated with only current primary picture layer among the at least one primary picture layer.

According to the embodiment of the present disclosure, in the method or the apparatus for encoding image information, the OMI related information may be present in the current primary picture layer.

According to the embodiment of the present disclosure, in the method or the apparatus for encoding image information, the image information may further include at least one auxiliary layer associated with the current primary picture layer. The OMI related message may include information on the at least one auxiliary layer.

According to the embodiment of the present disclosure, in the method or the apparatus for encoding image information, the information on the at least one auxiliary layer may include information on a object mask of the at least one auxiliary layer.

According to the embodiment of the present disclosure, in the method or the apparatus for encoding image information, the OMI related information may further include OMI persistence flag information indicating persistence of the object mask information of the OMI related information. Object mask information of the OMI related information may be applied only for a current picture based on a value of the OMI persistence flag information equal to 0. The object mask information of the OMI related information may be applied for the current picture and subsequent pictures in the current primary picture layer based on a value of the OMI persistence flag information equal to 1.

According to an embodiment of the present disclosure, a computer-readable storage medium storing a bitstream generated by an encoding method. The encoding method includes generating at least one object mask information (OMI) related message associated with at least one primary picture layer among a plurality of layers, respectively; and encoding the image information including the OMI related message. An OMI related message among the at least one OMI related message is associated with only current primary picture layer among the at least one primary picture layer.

The features of the present disclosure briefly summarized above are merely illustrative aspects of the detailed description of the present disclosure and do not limit the scope of the present disclosure.

According to the present disclosure, it is possible to provide an encoding/decoding method and/or apparatus with improved coding efficiency.

According to the present disclosure, it is possible to provide an encoding/decoding method and/or apparatus with improved data transmission efficiency.

According to the present disclosure, it is possible to provide an encoding/decoding method and/or apparatus that can reduce power consumption of a decoding apparatus and improve accuracy of image analysis.

Effects of the present disclosure are not limited to those described above, and other effects that have not been described above will be clearly understood by those skilled in the technical field to which the present disclosure pertains from the following description.

### BRIEF DESCRIPTION OF DRAWINGS

FIG. 1 is a view schematically showing a video coding system to which an embodiment of the present disclosure is applicable.

FIG. 2 is a diagram schematically illustrating an image encoding device to which an embodiment according to the present disclosure can be applied.

FIG. 3 is a schematic diagram illustrating an image decoding device to which an embodiment according to the present disclosure can be applied.

FIG. 4 exemplarily shows a hierarchical structure for coded video/image to which an embodiment according to the present disclosure can be applied.

FIG. 5 is a flowchart illustrating a method of decoding image information according to an embodiment of the present disclosure;

FIG. 6 is a flowchart illustrating a method of encoding image information according to an embodiment of the present disclosure;

FIG. 7 is a diagram exemplifying a content streaming system to which an embodiment according to the present disclosure can be applied.

### DETAILED DESCRIPTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

The present disclosure presents various embodiments of video/image coding, and unless otherwise stated, the embodiments may be performed in combination with each other.

The terms used in the present disclosure may have their usual meanings in the technical field to which the present disclosure belongs, unless newly defined in the present disclosure.

In the present disclosure, a “picture” generally means a unit representing one image of a specific time period, and a slice/tile is a coding unit constituting a part of a picture, and one picture may be composed of one or more slices/tiles. In addition, a slice/tile may include one or more CTUs (coding tree units). One picture may be composed of one or more tile groups. One tile group may include one or more tiles. A brick may represent a rectangular area of CTU rows of tiles in a picture. In this document, tile group and slice may be used interchangeably. For example, in this document, a tile group/tile group header may be called a slice/slice header.

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. One unit may include one luma block and two chroma (e.g., Cb, Cr) blocks. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The chroma component block of the current block may be expressed by including an explicit description of a chroma component block such as “chroma block” or “current chroma block.

In the present disclosure, the term “/” and “,” should be interpreted to indicate “and/or”. For instance, the expression “A/B” and “A, B” may mean “A and/or B.” Further, “A/B/C” and “A, B, C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

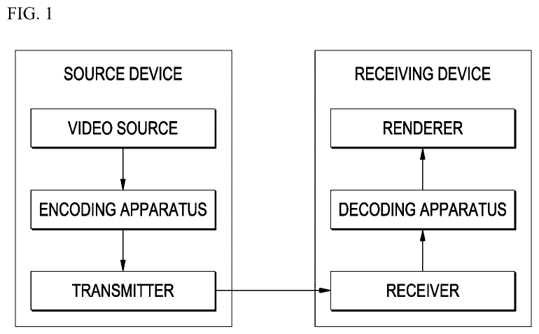

FIG. 1 is a view schematically showing a video coding system to which an embodiment of the present disclosure is applicable.

The video coding system according to an embodiment may include an encoding device 10 and a decoding device 20. The encoding device 10 may deliver encoded video and/or image information or data to the decoding device 20 in the form of a file or streaming via a digital storage medium or network.

The encoding device 10 according to an embodiment may include a video source generator 11, an encoder 12 and a transmitter 13. The decoding device 20 according to an embodiment may include a receiver 21, a decoder 22 and a renderer 23. The encoder 12 may be called a video/image encoding apparatus, and the decoder 22 may be called a video/image decoding apparatus. The transmitter 13 may be included in the encoder 12. The receiver 21 may be included in the decoder 22. The renderer 23 may include a display and the display may be configured as a separate device or an external component.

The video source generator 11 may obtain a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoder 12 may encode an input video/image. The encoder 12 may perform a series of procedures such as prediction, transform, and quantization for compression and coding efficiency. The encoder 12 may output encoded data (encoded video/image information) in the form of a bitstream.

The transmitter 13 may transmit the encoded video/image information or data output in the form of a bitstream to the receiver 21 of the decoding device 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream and transmit the bitstream to the decoder 22.

The decoder 22 may decode the video/image by performing a series of procedures such as dequantization, inverse transform, and prediction corresponding to the operation of the encoder 12.

The renderer 23 may render the decoded video/image. The rendered video/image may be displayed through the display.

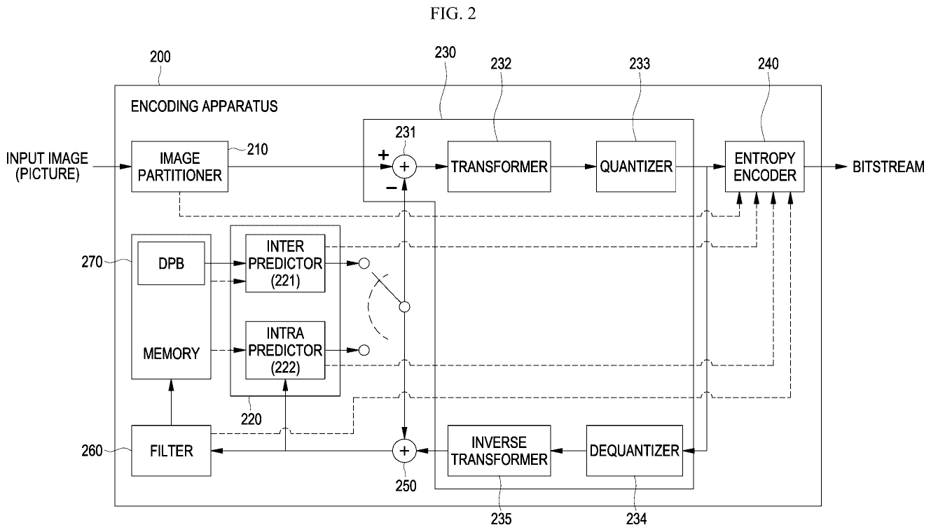

FIG. 2 is a diagram schematically illustrating an image encoding device to which an embodiment according to the present disclosure can be applied.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (ex. an encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to this document may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The term unit may be used interchangeably with terms such as block or area, depending on the case. In general, an M×N block can represent a set of samples or transform coefficients consisting of M columns and N rows. A sample can generally represent a pixel or a pixel value, and may represent only a pixel/pixel value of a luma component, or only a pixel/pixel value of a chroma component. A sample can be used as a term corresponding to a pixel or pel in a picture (or image).

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a unit for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in this document. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The subtraction unit 115 can subtract the prediction signal (predicted block, predicted sample array) output from the prediction unit 200 from the input image signal (original block, original sample array) to generate a residual signal (residual block, residual sample array). The generated residual signal can be transmitted to the conversion unit 232.

The transformer 232 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated.

The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (ex. values of syntax elements, etc.) together or separately. Encoded information (ex. encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In this document, information and/or syntax elements transmitted/signaled from the encoding apparatus to the decoding apparatus may be included in video/picture information. The video/image information may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235.

Meanwhile, LMCS (luma mapping with chroma scaling) may be applied during the picture encoding and/or restoration process.

The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus may be avoided and encoding efficiency may be improved.

The DPB of the memory 270 may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

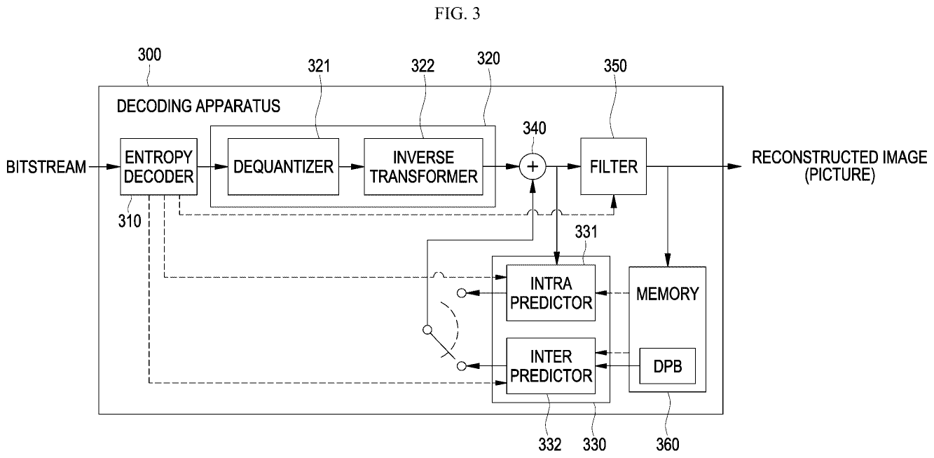

FIG. 3 is a schematic diagram illustrating an image decoding device to which an embodiment according to the present disclosure can be applied.

Referring to FIG. 3, the decoding apparatus 300 may include an entropy decoder 310, a residual processor 320, a predictor 330, an adder 340, a filter 350, a memory 360. The predictor 330 may include an inter predictor 331 and an intra predictor 332. The residual processor 320 may include a dequantizer 321 and an inverse transformer 321. The entropy decoder 310, the residual processor 320, the predictor 330, the adder 340, and the filter 350 may be configured by a hardware component (ex. a decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in this document may be decoded may decode the decoding procedure and obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to this document may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (ex. quantization step size information) and obtain transform coefficients.

The inverse transformer 322 inversely transforms the transform coefficients to obtain a residual signal (residual block, residual sample array).

The predictor 330 may generate a prediction signal based on various prediction methods described below. For example, the predictor may apply intra prediction or inter prediction for prediction of one block, and may also apply intra prediction and inter prediction at the same time. This may be called combined inter and intra prediction (CIIP). In addition, the predictor may be based on an intra block copy (IBC) prediction mode or a palette mode for prediction of a block. The IBC prediction mode or palette mode may be used for content image/video coding such as games, such as screen content coding (SCC). The IBC basically performs prediction within the current picture, but may be performed similarly to inter prediction in that it derives a reference block within the current picture. That is, the IBC may use at least one of the inter prediction techniques described in this document. The palette mode may be viewed as an example of intra coding or intra prediction. When palette mode is applied, information about the palette table and palette index may be signaled and included in the video/image information.

The intra predictor 332 may predict the current block by referring to the samples in the current picture. The referenced samples may be located in the neighborhood of the current block or may be located apart according to the prediction mode. In intra prediction, prediction modes may include a plurality of non-directional modes and a plurality of directional modes. The intra predictor 331 may determine the prediction mode applied to the current block by using the prediction mode applied to the neighboring block.

The inter predictor 331 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block. The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, LMCS (luma mapping with chroma scaling) may be applied during the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present disclosure, the embodiments described in the filter 260, the inter predictor 221, and the intra predictor 222 of the encoding apparatus 100 may be the same as or respectively applied to correspond to the filter 350, the inter predictor 332, and the intra predictor 331 of the decoding apparatus 300. The same may also apply to the unit 332 and the intra predictor 331.

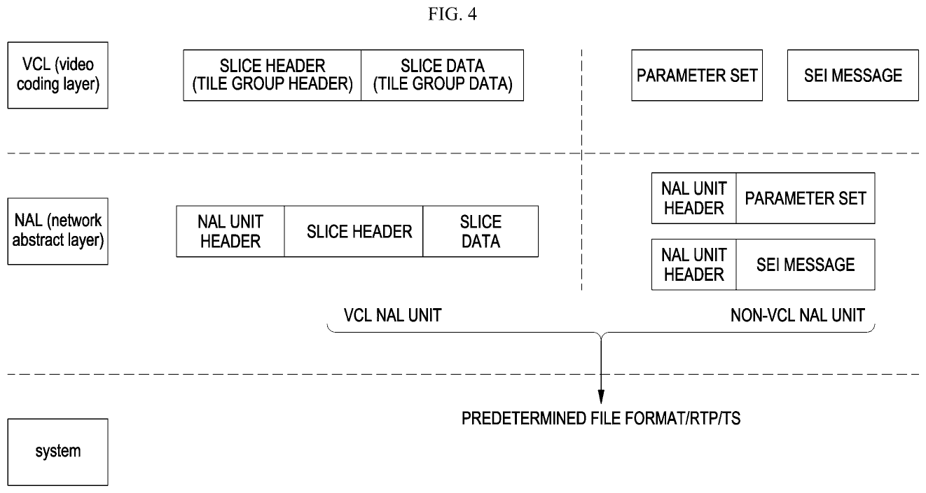

FIG. 4 exemplarily shows a hierarchical structure for coded video/image to which an embodiment according to the present disclosure can be applied.

Referring to FIG. 4, coded image/video is divided into a VCL (video coding layer) that handles the decoding process of the image/video and itself, a subsystem that transmits and stores the coded information, and NAL (network abstraction layer) in charge of function and present between the VCL and the subsystem.

In the VCL, VCL data including compressed image data (slice data) is generated, or a parameter set including a picture parameter set (PSP), a sequence parameter set (SPS), and a video parameter set (VPS) or a supplemental enhancement information (SEI) message additionally required for an image decoding process may be generated.

In the NAL, a NAL unit may be generated by adding header information (NAL unit header) to a raw byte sequence payload (RBSP) generated in a VCL. In this case, the RBSP refers to slice data, parameter set, SEI message, etc., generated in the VCL. The NAL unit header may include NAL unit type information specified according to RBSP data included in the corresponding NAL unit.

As shown in the figure, the NAL unit may be classified into a VCL NAL unit and a Non-VCL NAL unit according to the RBSP generated in the VCL. The VCL NAL unit may mean a NAL unit that includes information on the image (slice data) on the image, and the Non-VCL NAL unit may mean a NAL unit that includes information (parameter set or SEI message) required for decoding the image.

The above-described VCL NAL unit and Non-VCL NAL unit may be transmitted through a network by attaching header information according to the data standard of the subsystem. For example, the NAL unit may be transformed into a data format of a predetermined standard such as an H.266/VVC file format, a real-time transport protocol (RTP), a transport stream (TS), etc., and transmitted through various networks.

As described above, the NAL unit may be specified with the NAL unit type according to the RBSP data structure included in the corresponding NAL unit, and information on the NAL unit type may be stored and signaled in the NAL unit header.

For example, the NAL unit may be classified into a VCL NAL unit type and a Non-VCL NAL unit type according to whether the NAL unit includes information (slice data) about an image. The VCL NAL unit type may be classified according to the nature and type of pictures included in the VCL NAL unit, and the Non-VCL NAL unit type may be classified according to types of parameter sets.

The following is an example of the NAL unit type specified according to the type of parameter set included in the Non-VCL NAL unit type.
APS (Adaptation Parameter Set) NAL unit: Type for NAL unit including APS
DPS (Decoding Parameter Set) NAL unit: Type for NAL unit including DPS
VPS (Video Parameter Set) NAL unit: Type for NAL unit including VPS
SPS (Sequence Parameter Set) NAL unit: Type for NAL unit including SPS
PPS (Picture Parameter Set) NAL unit: Type for NAL unit including PPS

The aforementioned NAL unit types may have syntax information for the NAL unit type, and the syntax information may be stored and signaled in a NAL unit header. For example, the syntax information may be nal_unit_type, and NAL unit types may be specified by a nal_unit_type value.

The slice header (slice header syntax) may include information/parameters that may be commonly applied to the slice. The APS (APS syntax) or the PPS (PPS syntax) may include information/parameters that may be commonly applied to one or more slices or pictures. The SPS (SPS syntax) may include information/parameters that may be commonly applied to one or more sequences. The VPS (VPS syntax) may include information/parameters that may be commonly applied to multiple layers. The DPS (DPS syntax) may include information/parameters that may be commonly applied to the overall video. The DPS may include information/parameters related to concatenation of a coded video sequence (CVS). High level syntax (HLS) in this document may include at least one of the APS syntax, PPS syntax, SPS syntax, VPS syntax, DPS syntax, a picture header syntax and slice header syntax.

In this document, the image/video information encoded from the encoding apparatus and signaled to the decoding apparatus in the form of a bitstream includes not only partitioning related information in a picture, intra/inter prediction information, residual information, in-loop filtering information, etc, but also information included in a slice header, information included in the picture header, information included in the APS, information included in the PPS, information included in an SPS, information included in a VPS and/or information included in a DPS.

The SEI message related to the present invention is described.

Table 1 shows an example of an Object mask information SEI message syntax.

TABLE 1

| | Descriptor |
|---|---|
| object_mask_info( payloadSize ) { | |
| omi_cancel_flag | u(1) |
| if( !omi_cancel_flag ) { | |
| omi_aux_id_minus128 | ue(v) |
| omi_num_primary_pic_layer_minus1 | ue(v) |
| for( i = 0; i <= omi_num_primary_pic_layer_minus1; i++ ) { | |
| omi_primary_pic_layer_id[ i ] | uc(v) |
| omi_num_aux pic[ i ] | ue(v) |
| } | |
| omi_mask_id_length_minus1 | ue(v) |
| omi_mask_sample_value_length_minus8 | ue(v) |
| omi_mask_confidence_info_present_flag | u(1) |
| if( omi_mask_confidence_info_present_flag ) | |
| omi_mask_confidence_length_minus1 | u(4) |
| omi_mask_depth_info_present_flag | u(1) |
| if( omi_mask_depth_info_present_flag ) | |
| omi_mask_depth_length_minus1 | u(4) |
| omi_mask_label_info_present_flag | u(1) |
| if( omi_mask_label_info_present_flag ) { | |
| omi_mask_label_language_present_flag | u(1) |
| if( omi_mask_label_language_present_flag ) { | |
| while( !byte_aligned( ) ) | |
| omi_bit_equal_to_zero | f(1) |
| omi_mask_label_language | st(v) |
| } | |
| } | |
| for( i = 0; i <= omi_num_primary_pic_layer_minus1; i++) | |
| for( j = 0; j < omi_num_aux_pic[ i ]; j++ ) { | |
| omi_mask_pic_update_flag[ i ][ j ] | f(1) |
| if( omi_mask_pic_update_flag[ i ][ j ] ) { | |
| omi_num_mask_in_pic_update[ i ][ j ] | uc(v) |
| for( k = 0; k < omi_num_mask_in_pic_update[ i ][ j ]; k++ ) { | |
| omi_mask_id[ i ][ j ][ k ] | u(v) |
| omi_aux_sample_value[ i ][ j ][ k ] | u(v) |
| omi_mask_bounding_box_present_flag[ i ][ j ][ k ] | u(1) |
| if( omi_mask_bounding_box_present_flag[ i ][ j ][ k ] ) { | |
| omi_mask_top[ i ][ j ][ k ] | u(16) |
| omi_mask_left[ i ][ j ][ k ] | u(16) |
| omi_mask_width[ i ][ j ][ k ] | u(16) |
| omi_mask_height[ i ][ j ][ k ] | u(16) |
| } | |
| omi_mask_cancel[ i ][ j ][ k ] | u(1) |
| if( !omi_mask_cancel[ i ][ j ][ k ] ) { | |
| if( omi_mask_confidence_info_present_flag ) | |
| omi_mask_confidence[ i ][ j ][ k ] | u(v) |
| if( omi_mask_depth_info_present_flag ) | |
| omi_mask_depth[ i ][ j ][ k ] | u(v) |
| while( !byte_aligned( ) ) | |
| omi_bit_equal_to_zero | f(1) |
| if( omi_mask_label_info_present_flag ) | |
| omi_mask_label[ i ][ j ][ k ] | st(v) |
| } | |
| } | |
| } | |
| } | |
| } | |
| } | |

The object mask information (OMI) SEI message provides information about object mask pictures coded as auxiliary pictures.

Use of this SEI message requires the definition of the following variables:

A cropped picture width and picture height in units of luma samples, denoted herein by CroppedWidth and CroppedHeight, respectively.
A conformance cropping window left offset, ConfWinLeftOffset
A conformance cropping window top offset, ConfWinTopOffset

A chroma format indicator, denoted herein by ChromaFormatIdc, as described in clause 7.3.

The variables SubWidthC and SubHeightC are derived from ChromaFormatIdc as specified by Table 2.

When an access unit contains an auxiliary picture picA in a layer, with nuh_layer_id equal to nuhLayerIdA, that is indicated as an object mask auxiliary layer by an OMI SEI message, and a primary picture picB in a layer, with nuh_layer_id equal to nuhLayerIdB, that is indicated as a primary layer by the OMI SEI message, OMI SEI message persists in output order until one or more of the following conditions are true:

A CLVS containing the auxiliary picture picA ends.

A CLVS containing the primary picture picB ends.

A CVS ends.

The bitstream ends.

The omi_cancel_flag equal to 1 indicates that the SEI message cancels the persistence of any previous object mask information SEI message in output order.

The omi_cancel_flag equal to 0 indicates that object mask information follows.

The omi_aux_id_minus128 plus 128 indicates the value of sdi_aux_id of object mask auxiliary picture layer. The om_aux_id_minus128 shall be in the range of 0 to 31, inclusive.

When a CVS does not contain an SDI SEI message with sdi_aux_id[i] equal to omi_aux_id_minus128+128 for at least one value of i, no picture in the CVS shall be associated with an OMI SEI message.

When an AU contains both an SDI SEI message with sdi_aux_id[i] equal to omi_aux_id_minus128+128 for at least one value of i and an OMI SEI message, the SDI SEI message shall precede the OMI SEI message in decoding order.

The omi_num_primary_pic_layer_minus1 plus 1 indicates the number of primary picture layers associated with the object mask auxiliary picture layers to which this SEI message applies. The value of omi_num_primary_pic_layer_minus1 shall be in the range of 0 to sdi_max_layers_minus1.

The omi_primary_pic_layer_id[i] specifies the nuh_layer_id value of the i-th primary picture layer that is associated with the object mask auxiliary picture layers to which this OMI SEI message applies. The value of sdi_aux_id[j] shall be equal to 0 for any value of j in the range of 0 to sid_max_layers_minus1, inclusive, if sdi_layer_id[j] equal to omi_primary_pic_layer_id[i].

The omi_num_aux_pic[i] indicates the number of auxiliary picture layers associated with the i-th primary picture layer that is associated with the object mask auxiliary picture layers. It is a requirement of bitstream conformance that the value of omi_num_aux_pic[i] shall be equal to numAuxLayer[omi_primary_pic_layer_id[i]] for i form 0 to omi_num_primary_pic_layer_minus1, inclusive, where the variable numAuxLayer[primaryLayerId] indicating the number of the object mask auxiliary picture layers associated with primary picture layer with nuh_layer_id equal to primaryLayerId is derived as follows.

```
TABLE 2
for( i = 0; i <= sdi_max_max_layers_minus1; i++ )
  numAuxLayer[ sdi_layer_id[ i ] ] = 0;
for( i = 0; i <= sdi_max_layers_minus1; i++ ) {
  if( sdi_aux_id[ i ] = = omi_aux_id_minus128 + 128 ) {
    for( j = 0; j <= sdi_num_associated_primary_layers_minus1[ i ]; j++ ) {
      primaryLayerId = sdi_layer_id[ sdi_associated_primary_layer_idx[ i ][ j ] ] ];
    }
  }
}
```

The omi_mask_id_length_minus1 plus 1 specifies the length, in bits, of omi_mask_id[i][j][k] syntax elements.

The omi_mask_sample_value_length_minus8 plus 8 specifies the length, in bits, of omi_aux_sample_value[i][j][k] syntax elements. The value of omi_mask_sample_value_length_minus8 shall be in the range of 0 to 8.

The omi_mask_confidence_info_present_flag equal to 1 indicates that omi_mask_confidence[i][j][k] syntax elements are present. omi_mask_confidence_info_present_flag equal to 0 indicates that omi_mask_confidence[i][j][k] syntax elements are not present.

The omi_mask_confidence_length_minus1 plus 1 specifies the length, in bits, of the omi_mask_confidence[i][j][k] syntax elements.

The omi_mask_depth_info_present_flag equal to 1 indicates that omi_mask_depth[i][j][k] syntax elements are present. omi_mask_depth_info_present_flag equal to 0 indicates that omi_mask_depth[i][j][k] syntax elements are not present.

The omi_mask_depth_length_minus1 plus 1 specifies the length, in bits, of the omi_mask_depth[i][j][k] syntax elements.

It is a requirement of bitstream conformance that the value of omi_aux_id_minus128, omi_num_primary_pic_layer_minus1, omi_primary_pic_layer_id[i], omi_num_aux_pic[i], omi_mask_id_length_minus1 and omi_mask_sample_value_length_minus8, omi_mask_confidence_length_minus1, omi_mask_confidence_info_present_flag, omi_mask_depth_info_present_flag and omi_mask_depth_length_minus1 shall be the same for all object_mask_info( ) syntax structures within a CVS.

The omi_mask_label_info_present_flag equal to 1 indicates that omi_mask_label_language_present_flag and omi_mask_label[i][j][k] syntax elements are present. omi_mask_label_info_present_flag equal to 0 indicates that omi_mask_label_language_present_flag and omi_mask_label[i][j][k] syntax elements are not present.

The omi_mask_label_language_present_flag equal to 1 indicates that omi_mask_label_language syntax element is present. omi_mask_label_language_present_flag equal to 0 indicates that omi_mask_label_language syntax element is not present.

The omi_bit_equal_to_zero shall be equal to 0.

The omi_mask_label_language contains a language tag as specified by IETF RFC 5646 followed by a null termination byte equal to 0x00. The length of the omi_mask_label_language syntax element shall be less than or equal to 255 bytes, not including the null termination byte. When not present, the language of the label is unspecified.

The omi_mask_pic_update_flag[i][j] equal to 1 indicates the mask information of j-th object mask auxiliary picture associated with i-th primary picture is signalled. The omi_mask_pic_update_flag[i][j] equal to 0 indicates the mask information of j-th object mask auxiliary picture associated with i-th primary picture is not signalled. When the mask information of j-th object mask auxiliary picture associated with i-th primary picture is not present, the persistence mechanism is used, that is the information is inherited from the last OMI SEI message which signals the mask information of j-th object mask auxiliary picture associated with i-th primary picture.

The omi_num_mask_in_pic_update[i][j] indicates the number of object masks of which the information is signalled in the j-th object mask auxiliary picture associated with i-th primary picture. omi_num_mask_in_pic_update[i][j] shall be in the range of 0 to (1<< (omi_mask_id_length_minus1+1))−1, inclusive.

The omi_mask_id[i][j][k] indicates the identifier of k-th signaled object mask in the j-th object mask auxiliary picture associated with the i-th primary picture. The length of the omi_mask_id[i][j][k] syntax element is omi_mask_id_length_minus1+1 bits.

The variable maskId[i][j][k] specifying the global identifier of k-th signaled object mask in the j-th object mask auxiliary picture associated with i-th primary picture in the SEI message is derived as follows:

```
TABLE 3
for( i = 0; i <= omi_num_primary_pic_layer_minus1; i++ ) {
  for( j = 0; j < omi_num_aux_pic[ i ]; j+ + ) {
    for( k = 0; k < omi_num_mask_in_pic_update[ i ][ j ]; k++ ) {
      maskId[ i ][ j ][ k ] = omi_mask_id[ i ][ j ][ k ] + (1<<(omi_mask_id_length_minus1 + 1))*j
    }
  }
}
```

The omi_mask_bounding_box_present_flag[i][j][k] equal to 1 indicates the syntax elements omi_mask_top[i][j][k], omi_mask_left[i][j][k], omi_mask_width[i][j][k], and omi_mask_height[i][j][k], are present. omi_mask_bounding_box_present_flag[i][j][k] equal to 0 indicates syntax elements, omi_mask_top[i][j][k], omi_mask_left[i][j][k], omi_mask_width[i][j][k], and omi_mask_height[i][j][k], are not present.

The omi_mask_top[i][j][k], omi_mask_left[i][j][k], omi_mask_width[i][j][k], and omi_mask_height[i][j][k] indicate the coordinates of the top-left corner and the width and height, respectively, of the bounding box in the cropped decoded picture of the k-th signaled object mask in the j-th object mask auxiliary picture associated with the i-th primary picture, relative to the conformance cropping window specified by the active SPS.

The value of omi_mask_left[i][j][k] shall be in the range of 0 to (CroppedWidth/SubWidthC−1), inclusive, CroppedWidth and SubWidthC being associated to the j-th object mask auxiliary picture associated with i-th primary picture. When it is not present, the value of omi_mask_left[i][j][k] is inferred to be 0.

The value of omi_mask_top[i][j][k] shall be in the range of 0 to (CroppedHeight/SubHeightC−1), inclusive, CroppedHeight and SubHeightC being associated to the j-th object mask auxiliary picture associated with i-th primary picture. When it is not present, the value of omi_mask_top[i][j][k] is inferred to be 0.

The value of omi_mask_width[i][j][k] shall be in the range of 0 to (CroppedWidth/SubWidthC-omi_mask_left[i][j][k]), inclusive. When it is not present, the value of omi_mask_width[i][j][k] is inferred to be (CroppedWidth/SubWidthC-omi_mask_left[i][j][k]).

The value of omi_mask_height[i][j][k] shall be in the range of 0 to (CroppedHeight/SubHeightC-omi_mask_top[i][j][k]), inclusive. When it is not present, the value of omi_mask_height[i][j][k] is inferred to be (CroppedHeight/SubWidthC-omi_mask_top[i][j][k]).

The identified object mask is within a bounding box containing luma samples with horizontal coordinates from SubWidthC*(ConfWinLeftOffset+omi_mask_left[i][j][k]) to SubWidthC*(ConfWinLeftOffset+omi_mask_left[i][j][k]+omi_mask_width[i][j][k])−1, inclusive, and vertical coordinates from SubHeightC*(ConfWinTopOffset+omi_mask_top[i][j][k]) to SubHeightC*(ConfWinTopOffset+omi_mask_top[i][j][k]+omi_mask_height[i][j][k])−1, inclusive.

Variable pI[i][j][x][y] is the decoded value of the sample at the relative sample location (x, y) in the cropped j-th object mask auxiliary picture associated with the i-th primary picture.

The following table 4 is to determine mask region in a auxiliary picture.

```
TABLE 4
for( i = 0; i <= omi_num_primary_pic_layer_minus1; i++ ) {
  for( j = 0; j < omi_num_aux_pic[ i ]; j++ ) {
    for( k = 0; k < omi_num_mask_in_pic_update[ i ][ j ]; k++ ) {
      if( pl[ i ][ j ][ x ][ y ] == omi_aux_sample_value [ i ][ j ][ k ]
          && x >= omi_mask_left[ i ][ j ][ k]
          && x < omi_mask_left[ i ][ j ][ k ] + omi_mask_width[ i ][ j ][ k ]
          && y >= omi_mask_top[ i ][ j ][ k]
          && y < omi_mask_top[ i ][ j ][ k ] + omi_mask_height[ i ][ j ][ k ])
        The sample at location (x, y) in the cropped j-th object mask auxiliary picture associated
        with the i-th primary picture is associated with the object mask with the identifier of
        maskld[ i ][ j ][ k ]
    }
  }
}
```

The omi_mask_cancel[i][j][k] equal to 1 cancels the persistence scope of the k-th signaled object mask in the j-th object mask auxiliary picture associated with the i-th primary picture. omi_mask_cancel[i][j][k] equal to 0 indicates the information of the k-th signaled object mask in the j-th object mask auxiliary picture associated with the i-th primary picture is signalled.

It is a requirement of bitstream conformance that when omi_mask_id[i][j][k] with a particular value is parsed for the first time in the current CLVS, the value of the corresponding omi_mask_cancel[i][j][k] shall be equal to 0.

The omi_mask_confidence[i][j][ ] indicates the degree of confidence associated with the k-th signaled object mask in the j-th object mask auxiliary picture associated with i-th primary picture, in units of 2−(omi_mask_confidence_length_minus1+1), such that a higher value of omi_mask_confidence[i][j][k] indicates a higher degree of confidence. The length of the omi_mask_confidence[i][j][k] syntax element is omi_mask_confidence_length_minus1+1 bits.

The omi_mask_depth[i][j][k] indicates the object depth associated with the k-th signaled object mask in the j-th object mask auxiliary picture associated with i-th primary picture. A smaller value of omi_mask_depth indicates a shorter distance to the object. The length of the omi_mask_depth[i][j][k] syntax element is omi_mask_depth_length_minus1+1 bits.

The omi_mask_label[i][j][k] specifies the contents of the label associated with k-th signaled object mask in the j-th object mask auxiliary picture associated with i-th primary picture. The length of the omi_mask_label[i][j][k] syntax element shall be less than or equal to 255 bytes, not including the null termination byte.

In the current design of object mask information (OMI) SEI message, the SEI message contains object mask information for all layers within one SEI message. Such design is asserted to have at least the following problems:

In the case where there are multiple primary picture layers, having object mask information for all layers in one SEI make it difficult for bitstream thinning case (i.e., removal of some one or more layers) since it may require updates to the SEI message content.

Any changes to object mask information in one layer would require update to the SEI which also includes information for all other layers. This is asserted to be not efficient.

In the case of persistence cancellation, the current design would need to cancel persistence of object mask information for all primary picture layers at the same time. This is not a good design since it requires synchronization of all primary picture layers.

In the current design of object mask information (OMI) SEI message, the SEI message contains object mask information for all layers within one SEI message. Such design is asserted to have at least the following problems:

A summary of an example is as follows.

Modify the design of signalling object mask information in Object Mask Information (OMI) SEI message such that one OMI SEI message contains object mask information for pictures in one primary picture layer only.

One primary picture layer may have object mask information from auxiliary pictures in one or more auxiliary picture layers. This auxiliary picture layers are call associated auxiliary picture layers.

There is only one active OMI SEI message in a primary picture layer at any particular time.

The presence of an OMI SEI message cancels the persistence of previous OMI SEI message in the same primary picture layer.

When an OMI SEI message with cancel flag equal to 1, it cancels the persistence of previous OMI SEI message in the same primary picture layer.

An embodiment proposed by the present disclosure is described in detail as follows.

An embodiment provides a description of the summary described above.

Table 5 shows the syntax of an object mask information SEI message according to an embodiment.

TABLE 5

| | Descriptor |
|---|---|
| object_mask_info( payloadSize ) { | |
| omi_cancel_flag | u(1) |
| if( !omi_cancel_flag ) { | |
| omi_persistence_flag | u(1) |
| omi_aux_id_minus128 | ue(v) |
| omi_primary_pic_layer_id | ue(v) |
| omi_num_aux_pic | ue(v) |
| omi_mask_id_length_minus1 | ue(v) |
| omi_mask_sample_value_length_minus8 | ue(v) |
| omi_mask_confidence_info_present_flag | u(1) |
| if( omi_mask_confidence_info_present_flag ) | |
| omi_mask_confidence_length_minus1 | u(4) |
| omi_mask_depth_info_present_flag | u(1) |
| if( omi_mask_depth_info_present_flag ) { | |
| omi_mask_depth_length_minus1 | u(4) |
| omi_mask_label_info_present_flag | u(1) |
| if( omi_mask_label_info_present_flag ) { | |
| omi_mask_label_language_present_flag | u(1) |
| if( omi_mask_label_language_present_flag ) { | |
| while( !byte_aligned( ) ) | |
| omi_bit_equal_to_zero | f(1) |
| omi_mask_label_language | st(v) |
| } | |
| } | |
| for( i = 0; i < omi_num_aux_pic; i++ ) { | |
| omi_mask_pic_update_flag[ i ] | f(1) |
| if( omi_mask_pic_update_flag[ i ] ) { | |
| omi_num_mask_in_pic_update[ i] | ue(v) |
| for( j = 0; j < omi_num_mask_in pic_update[ i ]; j++) { | |
| omi_mask_id[ i ][ j ] | u(v) |
| omi_aux_sample_value[ i ][ j ] | u(v) |
| omi_mask_bounding_box present_flag[ i ][ j ] | u(1) |
| if( omi_mask_bounding_box_present_flag[ i ][ j ] ) { | |
| omi_mask_top[ i ][ j ] | u(16) |
| omi_mask_left[ i ][ j ] | u(16) |
| omi mask_width[ i ][ j ] | u(16) |
| omi_mask_height[ i ][ j ] | u(16) |
| } | |
| omi mask_cancel[ i ][ j ] | u(1) |
| if( !omi_mask_cancel[ i ][ j ] ) { | |
| if( omi_mask_confidence_info_present_flag ) | |
| omi_mask_confidence[ i ][ j ] | u(v) |
| if( omi_mask_depth_info_present_flag ) | |
| omi_mask_depth[ i ][ j ] | u(v) |
| while( !byte_aligned( ) ) | |
| omi_bit_equal_to_zero | f(1) |
| if( omi_mask_label_info_present_flag ) | |
| omi_mask_label[ i ][ j ] | st(v) |
| } | |
| } | |
| } | |
| } | |
| } | |
| } | |

The object mask information (OMI) SEI message provides object masking information for pictures in the layers associated with the SEI message. The object masking information is present in auxiliary pictures that may be present in one or more associated auxiliary picture layers. Each of the associated auxiliary layer shall have nuh_layer_id equal to sdi_layer_id[i], for any value of i in range of 0 to sid_max_layers_minus1, inclusive. The layer where the pictures associated with the OMI SEI message is referred to as the primary picture layer. The auxiliary layers containing object mask data associated with the pictures in the primary picture layer are referred to as associated auxiliary picture layers.

Use of this SEI message requires the definition of the following variables:

A cropped picture width and picture height in units of luma samples, denoted herein by CroppedWidth and CroppedHeight, respectively.
A conformance cropping window left offset, ConfWinLeftOffset
A conformance cropping window top offset, ConfWinTopOffset

A chroma format indicator, denoted herein by ChromaFormatIdc, as described in clause 7.3.

The variables SubWidthC and SubHeightC are derived from ChromaFormatIdc.

The omi_cancel_flag equal to 1 indicates that the SEI message cancels the persistence of any previous object mask information SEI message in the primary picture layer, if present, in output order. omi_cancel_flag equal to 0 indicates that object mask information follows.

The omi_persistence_flag specifies the persistence of the object mask information provided in this SEI message. omi_persistence_flag equal to 0 specifies that the object mask information applies for the current picture only. omi_persistence_flag equal to 1 specifies that the object mask information applies for the current picture and all subsequent pictures of the primary picture layer in output order until one or more of the following conditions are true:

A new CLVS of the primary picture layer begins.

The bitstream ends.

A picture in the current layer associated with an object mask information SEI message is output that follows the current picture in output order.

omi_aux_id_minus128 plus 128 indicates the value of sdi_aux_id of object mask auxiliary picture layer. om_aux_id_minus128 shall be in the range of 0 to 31, inclusive.

When a CVS does not contain an SDI SEI message with sdi_aux_id[i] equal to omi_aux_id_minus128+128 for i in range of 0 to sid_max_layers_minus1, inclusive, no picture in the CVS shall be associated with an OMI SEI message.

When an AU contains both an SDI SEI message with sdi_aux_id[i] equal to omi_aux_id_minus128+128 for at least one value of i and an OMI SEI message, the SDI SEI message shall precede the OMI SEI message in decoding order.

The omi_primary_pic_layer_id specifies the nuh_layer_id of the primary picture layer. The value of sdi_aux_id[i] shall be equal to 0 for any value of i in the range of 0 to sid_max_layers_minus1, inclusive, if sdi_layer_id[i] equal to omi_primary_pic_layer_id.

The omi_num_aux_pic indicates the number of associated auxiliary layers associated with the primary layer. It is a requirement of bitstream conformance that the value of omi_num_aux_pic shall be equal to numAuxLayer[omi_primary_pic_layer_id, where the variable numAuxLayer[omi_primary_pic_layer_id] indicating the number of the associated auxiliary layers is derived as Table 6:

```
TABLE 6
primaryLayerIdx = layer index associated with omi_primary_pic_layer_id
numAuxLayer = 0;
for( i = 0; i <= sdi_max_layers_minus1; i++ )
  if( sdi_aux_id[ i ] = = omi_aux_id_minus128 + 128 )
    for( j = 0; ] <= sdi_num_associated_primary_layers_minus1[ i ]; j++ )
      if (sdi_associated_primary_layer_idx[ i ][ j ] = = primaryLayerIdx)
        numAuxLayer++;
```

The omi_mask_id_length_minus1 plus 1 specifies the length, in bits, of omi_mask_id[i][j][k] syntax elements.

The omi_mask_sample_value_length_minus8 plus 8 specifies the length, in bits, of omi_aux_sample_value[i][j][k] syntax elements. The value of omi_mask_sample_value_length_minus8 shall be in the range of 0 to 8.

The omi_mask_confidence_info_present_flag equal to 1 indicates that omi_mask_confidence[i][j][k] syntax elements are present.

omi_mask_confidence_info_present_flag equal to 0 indicates that omi_mask_confidence[i][j][k] syntax elements are not present.

The omi_mask_confidence_length_minus1 plus 1 specifies the length, in bits, of the omi_mask_confidence[i][j][k] syntax elements.

The omi_mask_depth_info_present_flag equal to 1 indicates that omi_mask_depth[i][j][k] syntax elements are present. omi_mask_depth_info_present_flag equal to 0 indicates that omi_mask_depth[i][j][k] syntax elements are not present.

The omi_mask_depth_length_minus1 plus 1 specifies the length, in bits, of the omi_mask_depth[i][j][k] syntax elements.

It is a requirement of bitstream conformance that the value of omi_aux_id_minus128, omi_num_primary_pic_layer_minus1, omi_primary_pic_layer_id[i], omi_num_aux_pic[i], omi_mask_id_length_minus1 and omi_mask_sample_value_length_minus8, omi_mask_confidence_info_present_flag, omi_mask_confidence_length_minus1, omi_mask_depth_info_present_flag and omi_mask_depth_length_minus1 shall be the same for all object_mask_info( ) syntax structures within a CVS.

The omi_mask_label_info_present_flag equal to 1 indicates that omi_mask_label_language_present_flag and omi_mask_label[i][j][k] syntax elements are present.

The omi_mask_label_info_present_flag equal to 0 indicates that omi_mask_label_language_present_flag and omi_mask_label[i][j][k] syntax elements are not present.

The omi_mask_label_language_present_flag equal to 1 indicates that omi_mask_label_language syntax element is present. omi_mask_label_language_present_flag equal to 0 indicates that omi_mask_label_language syntax element is not present.

The omi_bit_equal_to_zero shall be equal to 0.

The omi_mask_label_language contains a language tag as specified by IETF RFC 5646 followed by a null termination byte equal to 0x00. The length of the omi_mask_label_language syntax element shall be less than or equal to 255 bytes, not including the null termination byte. When not present, the language of the label is unspecified.

The omi_mask_pic_update_flag[i] equal to 1 indicates that update for the mask information from the i-th associated auxiliary picture layer is signalled. omi_mask_pic_update_flag[i] equal to 0 indicates there is no change to the mask information from the i-th associated auxiliary picture layer. When omi_mask_pic_update_flag[i] is equal to 0, the persistence mechanism is used, that is the information is inherited from the last OMI SEI message associated with the primary picture layer which signals the mask information from the i-th associated auxiliary picture layer.

The omi_num_mask_in_pic_update[i] specifies the number of object masks of which the information is signalled in the i-th associated auxiliary picture layer. omi_num_mask_in_pic_update[i] shall be in the range of 0 to (1<< (omi_mask_id_length_minus1+1))−1, inclusive.

The omi_mask_id[i][j] indicates the identifier of the j-th object mask in the i-th associated auxiliary picture layer. The length of the omi_mask_id[i][j] syntax element is omi_mask_id_length_minus1+1 bits.

The variable maskId[i][j] specifying the global identifier of the j-th object mask in the i-th associated auxiliary picture layer is derived as Table 7:

```
TABLE 7
for( j = 0; j < omi_num_aux_pic; j++ ) {
  for( j = 0; j < omi_num_mask_in_pic_update[ i ]; j++ ) {
    maskId[ i ][ j ] = omi_mask_id[ i ][ ] ] + (1<<(omi_mask_id_length_minus1 + 1))*i
  }
}
```

The omi_mask_bounding_box_present_flag[i][j] equal to 1 specifies that the syntax elements omi_mask_top[i][j], omi_mask_left[i][j], omi_mask_width[i][j], and omi_mask_height[i][j], are present. omi_mask_bounding_box_present_flag[i][j] equal to 0 specifies that syntax elements, omi_mask_top[i][j], omi_mask_left[i][j], omi_mask_width[i][j], and omi_mask_height[i][j], are not present.

The omi_mask_top[i][j], omi_mask_left[i][j], omi_mask_width[i][j], and omi_mask_height[i][j] specify the coordinates of the top-left corner and the width and height, respectively, of the bounding box in the cropped decoded picture of the j-th signaled object mask in the i-th associated auxiliary layer, relative to the conformance cropping window specified by the active SPS.

The value of omi_mask_left[i][j] shall be in the range of 0 to (CroppedWidth/SubWidthC−1), inclusive, CroppedWidth and SubWidthC being associated to the i-th associated auxiliary picture layer. When it is not present, the value of omi_mask_left[i][j] is inferred to be 0.

The value of omi_mask_top[i][j] shall be in the range of 0 to (CroppedHeight/SubHeightC−1), inclusive, CroppedHeight and SubHeightC being associated to the i-th associated auxiliary picture layer. When it is not present, the value of omi_mask_top[i][j] is inferred to be 0.

The value of omi_mask_width[i][j] shall be in the range of 0 to (CroppedWidth/SubWidthC−omi_mask_left[i][j]), inclusive. When it is not present, the value of omi_mask_width[i][j] is inferred to be (CroppedWidth/SubWidthC-omi_mask_left[i][j]).

The value of omi_mask_height[i][j] shall be in the range of 0 to (CroppedHeight/SubHeightC−omi_mask_top[i][j]), inclusive. When it is not present, the value of omi_mask_height[i][j] is inferred to be (CroppedHeight/SubWidthC-omi_mask_top[i][j]).

The identified object mask is within a bounding box containing luma samples with horizontal coordinates from SubWidthC*(ConfWinLeftOffset+omi_mask_left[i][j]) to SubWidthC*(ConfWinLeftOffset+omi_mask_left[i][j]+omi_mask_width[i][j])−1, inclusive, and vertical coordinates from SubHeightC*(ConfWinTopOffset+omi_mask_top[i][j]) to SubHeightC*(ConfWinTopOffset+omi_mask_top[i][j]+omi_mask_height[i][j])−1, inclusive.

Variable pI[i][x][y] is the decoded value of the sample at the relative sample location (x, y) in the cropped i-th associated auxiliary layer. Table 8 is to determine mask region in a auxiliary picture.

```
TABLE 8
for( i = 0; i < omi_num_aux_pic; i++ ) {
  for( j = 0; j < omi_num_mask_in_pic_update[ i]; j++ ) {
    if( pl[ i ][ x ][ y ] == omi_aux_sample_value [ i ][ j ]
        && x >= omi_mask_left[ i ][ j ]
        && x < omi_mask_left[ i ][ j ] + omi_mask_width[ i ][ j ]
        && y >= omi_mask_top[ i ][ j ]
        && y < omi_mask_top[ i ][ j ] + omi_mask_height[ i ][ j ] )
      The sample at location (x, y) in the cropped i-th associated auxiliary picture layer
is associated with the object mask with the identifier of
      maskld[ i ][ j ] } }
  }
}
```

The omi_mask_cancel[i][j] equal to 1 cancels the persistence scope of the j-th signaled object mask in the i-th associated auxiliary picture layer. omi_mask_cancel[i][j] equal to 0 specifies that the information of the j-th signaled object mask in the i-th associated auxiliary picture layer.

It is a requirement of bitstream conformance that when omi_mask_id[i][j] with a particular value is parsed for the first time in the current CLVS, the value of the corresponding omi_mask_cancel[i][j] shall be equal to 0.

The omi_mask_confidence[i][j] specifies the degree of confidence associated with the j-th signaled object mask in the i-th associated auxiliary picture layer, in units of 2−(omi_mask_confidence_length_minus1+1), such that a higher value of omi_mask_confidence[i][j] indicates a higher degree of confidence. The length of the omi_mask_confidence[i][j] syntax element is omi_mask_confidence_length_minus1+1 bits.

The omi_mask_depth[i][j] specifies the object depth associated with the j-th signaled object mask in the i-th associated auxiliary picture layer. A smaller value of omi_mask_depth indicates a shorter distance to the object. The length of the omi_mask_depth[i][j] syntax element is omi_mask_depth_length_minus1+1 bits.

The omi_mask_label[i][j] specifies the contents of the label associated with j-th signaled object mask in the i-th associated auxiliary picture layer. The length of the omi_mask_label[i][j] syntax element shall be less than or equal to 255 bytes, not including the null termination byte.

Terms and names (e.g., names of syntax elements, names of variables, etc.) to be described below are mere examples, and the technical features of the present disclosure are not limited by the terms etc., to be described below. For example, image information to be described below may include various kinds of information according to embodiments described in the present disclosure and may include information shown in at least one of the above-described tables.

Operations to be described below are not essential elements of an embodiment, and at least some of the operations to be described below may be omitted. In addition, the operations to be described below are not sufficient elements of the embodiment, and the above-described operations may be added. Further, the operations to be described below are integrated with the above-described operations into the embodiment unless they contradict the above-described operations, and do not constitute an embodiment separately from the above-described operations.

As described above, image information encoded by an encoding apparatus or received by a decoding apparatus may include at least one primary layer including a picture and at least one auxiliary layer associated with each of the at least one primary layer. The primary layer is not limited by the name and is referred to by various names such as primary picture layer or the like. Also, the auxiliary layer is not limited by the name and is referred to by various names such as auxiliary picture layer or the like.

For example, the at least one auxiliary layer may be used in an object detection and tracking application for the primary layer. The encoding apparatus may perform image analysis on a picture of the primary layer and generate an object region, that is, an object mask, for an object detection and tracking task. The object mask may be transmitted to the decoding apparatus using a picture of the at least one auxiliary layer. When the object mask generated by the encoding apparatus is transmitted to the decoding apparatus, power consumption for an object detection and tracking task may be reduced at the decoding apparatus. In addition, the computation power of the encoding apparatus is generally superior to that of the decoding apparatus, enabling more accurate object detection and tracking.

Here, the image information may further include an OMI-related message including information on the object mask of the at least one auxiliary layer (hereinafter “object mask information”). In other words, the OMI-related message provides information on the object mask associated with the picture of the primary layer, and the object mask may be included in the picture of the auxiliary layer associated with the primary layer.

As described above, image information may include one or more primary layers including a picture, one or more auxiliary layers including object masks associated with each of the one or more primary layers, and one or more OMI-related messages including information on the object masks associated with each of the one or more primary layers.

For example, image information may include access units that include six layers (primary layers and auxiliary layers) as shown in table 9.

TABLE 9

| ID | Layer |
|---|---|
| 0 | First primary layer |
| 1 | Second primary layer |
| 2 | First auxiliary layer for layer 0 |
| 3 | Second auxiliary layer for layer 0 |
| 4 | Third auxiliary layer for layer 1 |
| 5 | Fourth auxiliary layer for layer 1 |

The image information may include a first primary layer (layer 0) and a second primary layer (layer 1) including primary pictures. The image information may include a first auxiliary layer (layer 2) including first object mask information of the first primary layer (layer 0) and a second auxiliary layer (layer 3) including second object mask information of the first primary layer (layer 0). Also, the image information may include a third auxiliary layer (layer 4) including third object mask information of the second primary layer (layer 1) and a fourth auxiliary layer (layer 5) including fourth object mask information of the second primary layer (layer 1).

Image information according to an embodiment may include one OMI-related message associated with both the first and second primary layers (example 1) or may include first and second OMI-related messages associated with the first and second primary layers, respectively (example 2).

Each example will be described below.

(Example 1) When one OMI-related message associated with both the first and second primary layers is provided, the OMI-related message may include all of the first and second object mask information of the first primary layer (layer 0) and the third and fourth object mask information of the second primary layer (layer 1). In other words, one OMI-related message may be provided for all the layers.

For example, the image information may include a series of access units including the first primary layer, the second primary layer, and one OMI-related message as shown in table 10.

TABLE 10

| Access unit | 0 | 1 | 2 | 3 | 4 | 5 | 6 | 7 | 8 | 9 |
|---|---|---|---|---|---|---|---|---|---|---|
| Object movement in first primary layer | O | X | X | O | X | X | X | O | X | X |
| Object movement in second primary layer | O | X | O | X | X | O | X | X | O | X |
| Signaling of OMI-related message | O | X | O | O | X | O | X | O | O | X |

As shown in table 10, an OMI-related message may be signaled (encoded or acquired) depending on whether there is movement of an object in pictures included in an access unit. Specifically, when there is movement of an object in a picture of the first primary layer or there is movement of an object in a picture of the second primary layer, an OMI-related message may be signaled (encoded or acquired).

Here, one OMI-related message may be activated for one or more primary layers.

For example, based on the presence of movement of an object in picture 0, picture 3, and picture 7 of the first primary layer and the presence of movement of an object in picture 0, picture 2, picture 5, and picture 8 of the second primary layer, access unit 0, access unit 2, access unit 3, access unit 5, access unit 7, and access unit 8 may include an OMI-related message.

Here, an application of the decoding apparatus may track only the object of the first primary layer. In other words, object mask information associated with the second primary layer may not be required. In this way, even when an OMI-related message associated with the second primary layer is not required, one OMI-related message is provided to all layers, and thus access unit 0, access unit 2, access unit 3, access unit 5, access unit 7, and access unit 8 include an OMI-related message. Accordingly, image information coding efficiency and image information transmission efficiency are reduced.

(Example 2) When a first OMI-related message associated with the first primary layer and a second OMI-related message associated with the second primary layer are provided, the first OMI-related message may include the first and second object mask information of the first primary layer (layer 0), and the second OMI-related message may include the third and fourth object mask information of the second primary layer (layer 1). In other words, one OMI-related message may be provided for each layer.

For example, the image information may include a series of access units including the first primary layer, the first OMI-related message, the second primary layer, and the second OMI-related message as shown in table 11.

TABLE 11

| Access unit | 0 | 1 | 2 | 3 | 4 | 5 | 6 | 7 | 8 | 9 |
|---|---|---|---|---|---|---|---|---|---|---|
| Object movement in first primary layer | O | X | X | O | X | X | X | O | X | X |
| Signaling of first OMI-related message | O | X | X | O | X | X | X | O | X | X |
| Object movement in second primary layer | O | X | O | X | X | O | X | X | O | X |
| Signaling of second OMI-related message | O | X | O | X | X | O | X | X | O | X |

As shown in table 11, the first OMI-related message and the second OMI-related message may be signaled (encoded or acquired) depending on whether there is movement of an object in pictures included in the first primary layer and the second primary layer, respectively. Specifically, when there is movement of an object in a picture of the first primary layer, the first OMI-related message may be signaled (encoded or acquired), and when there is movement of an object in a picture of the second primary layer, the second OMI-related message may be signaled (encoded or acquired).

Here, one OMI-related message may be activated for only one primary layer.

For example, based on the presence of movement of an object in picture 0, picture 3, and picture 7 of the first primary layer, access unit 0, access unit 3, and access unit 7 may include the first OMI-related message. Also, based on the presence of movement of an object in picture 0, picture 2, picture 5, and picture 8 of the second primary layer, access unit 0, access unit 2, access unit 5, and access unit 8 may include the second OMI-related message.

Here, the application of the decoding apparatus may require only object information of the first primary layer. In other words, object mask information associated with the second primary layer may not be required. In this way, when an OMI-related message associated with the second primary layer is not required, the second OMI-related message associated with the second primary layer may not be signaled (encoded or acquired). As a result, access unit 0, access unit 3, and access unit 7 may include the first OMI-related message, and access unit 2, access unit 5, and access unit 8 may not include the second OMI-related message. Accordingly, image information coding efficiency can be improved, and further, image information transmission efficiency can be improved.

As described above, transmitting one or more OMI-related messages for each of one or more primary layers can improve image information coding efficiency and image information transmission efficiency compared to transmitting one OMI-related message for all of one or more primary layers.

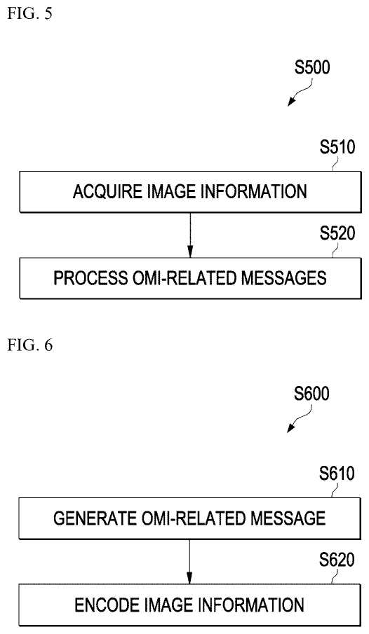

FIG. 5 is a flowchart illustrating a method of decoding image information according to an embodiment of the present disclosure.

Terms and names (e.g., names of syntax elements, names of variables, etc.) are mere examples, and the technical features of the present disclosure are not limited by the terms etc., illustrated in FIG. 5. For example, image information illustrated in FIG. 5 may include various kinds of information according to embodiments described in the present disclosure and may include information shown in at least one of the above-described tables.

A decoding method 500 may include operations to be described below. The operations to be described below are not essential elements of the decoding method according to the embodiment, and at least some of the operations to be described below may be omitted. In addition, the operations to be described below are not sufficient elements of the decoding method according to the embodiment, and the above-described operations may be added. Further, the operations to be described below are integrated with the above-described operations into the embodiment unless they contradict the above-described operations, and do not constitute an embodiment separately from the above-described operations.

The decoding method 500 may be executed by a decoding apparatus including a memory and a processor electrically connected to the memory, and may be executed by, for example, the processor.

The decoding apparatus may acquire image information (510).

As an example, the processor of the decoding apparatus may acquire image information. The image information may include one or more primary layers among a plurality of layers. Each of the one or more primary layers may include a picture which will be decoded. Here, the primary layer is not limited by the name and is referred to by various names such as primary picture layer or the like.

The image information may further include at least one auxiliary layer associated with one current primary layer among the one or more primary layers. Here, the auxiliary layer is not limited by the name and is referred to by various names such as auxiliary picture layer or the like.

For example, the at least one auxiliary layer may be used in an object detection and tracking application for the primary layers. The encoding apparatus may perform image analysis on a picture of the primary layer and provide information on an object region for an object detection and tracking task to the decoding apparatus. In this way, power consumption of the decoding apparatus can be reduced, and it is possible to detect and track an object more accurately. Accordingly, the at least one auxiliary layer may include an object mask for an object detection and tracking task for the primary layers.

The image information may include one or more OMI-related messages associated with each of the one or more primary layers. Specifically, an OMI-related message may include object mask information associated with each of the one or more primary layers.

In particular, the one or more OMI-related messages may be associated with each of the one or more primary layers. In other words, one of the one or more OMI-related messages may be associated with only one current primary layer among the one or more primary layers. Also, one OMI-related message may exist in one current primary layer.

The OMI-related messages may have various names, such as OMI supplemental enhancement information (SEI) message etc., and there is no limitation on the name.

The OMI-related messages may have various forms. For example, an OMI-related message may be a syntax element or a syntax structure including one or more syntax elements. In addition, an OMI-related message may be a raw byte sequence payload (RBSP) including one or more syntax elements or one or more syntax structures. For example, the OMI-related messages may be referred to as object_mask_info(payloadSize) etc., but are not limited thereto.

The OMI-related messages may include OMI cancellation flag information, OMI persistence flag information, primary layer identification information, auxiliary layer number information, information on an object mask, and the like.

The OMI cancellation flag information may indicate whether the persistence of a previous OMI-related message of a current OMI-related message is cancelled. For example, an OMI cancellation flag information value of 1 may indicate that the persistence of a previous OMI-related message existing in a current primary layer based on an output order is cancelled. Also, an OMI cancellation flag information value of 0 may indicate that the OMI cancellation flag information is followed by object mask information.

The OMI cancellation flag information may have various forms and may be referred to by various names. For example, the OMI cancellation flag information may be a syntax element or a syntax structure including one or more syntax elements. As an example, the OMI cancellation flag information which is a syntax element may be referred to as omi_cancel_flag etc., but is not limited thereto.

The OMI persistence flag information may indicate the persistence of object mask information included in the OMI-related messages. An OMI persistence flag information value of 1 may indicate that the object mask information included in the OMI-related messages is applied to not only a current picture but also subsequent pictures of all primary layers based on the output order. Also, an OMI persistence flag information value of 0 may indicate that the object mask information included in the OMI-related messages is applied to a current picture. However, the present disclosure is not limited thereto, and alternatively, what is specified by the OMI persistence flag information value of 1 may be exchanged with what is specified by the OMI persistence flag information value of 0.

The OMI persistence flag information may have various forms and may be referred to by various names. For example, the OMI persistence flag information may be a syntax element or a syntax structure including one or more syntax elements. As an example, the OMI persistence flag information which is a syntax element may be a persistence flag of one bit or a persistence indicator of two or more bits. OMI persistence flag information which is a syntax element may be referred to as omi_persistence_flag etc., but is not limited thereto.

The primary layer identification information may indicate identification information of a primary layer. The primary layer identification information may have various forms and may be referred to by various names. For example, the primary layer identification information may be a syntax element or a syntax structure including one or more syntax elements. As an example, the primary layer identification information which is a syntax element may be referred to as omi_primary_pic_layer_id etc., but is not limited thereto.

The auxiliary layer number information may indicate the number of auxiliary layers associated with a primary layer. The auxiliary layer number information may have various forms and may be referred to by various names. For example, the auxiliary layer number information may be a syntax element or a syntax structure including one or more syntax elements. As an example, the auxiliary layer number information which is a syntax element may be referred to as omi_num_aux_pic, omi_num_aux_pic_layer_minus1, etc., but is not limited thereto. When the auxiliary layer number information is referred to as omi_num_aux_pic_layer_minus1, a value acquired by adding 1 to the auxiliary layer number information may indicate the number of auxiliary layers associated with the primary layer.

The information on an object mask may include information indicating an object mask included in at least one auxiliary layer. For example, the information on an object mask may include information on a depth of the object mask, information on a label of the object mask, information on a position (top coordinates and left coordinates) of the object mask, information on a size (a width and height) of the object mask, and the like.

The decoding apparatus may process OMI-related messages (520).

For example, the processor of the decoding apparatus may process the OMI-related messages. The decoding apparatus may identify a current primary layer and at least one associated auxiliary layer on the basis of the OMI-related messages. The decoding apparatus may acquire information on at least one object mask of the current primary layer on the basis of the at least one associated auxiliary layer. Also, the decoding apparatus may detect at least one object included in a picture of a primary layer on the basis of the information on the at least one object mask and track the at least one object.

As described above, image information may include one or more primary layers, at least one auxiliary layer associated with the one or more primary layers, and one or more OMI-related messages associated with each of the one or more primary layers. The at least one auxiliary layer may include at least one object mask for detecting and tracking an object included in a picture in at least one primary layer.

Also, the one or more OMI-related messages may include information on the object mask associated with the one or more primary layers. Here, the one or more OMI-related messages are associated with each of the one or more primary layers. In other words, one of the one or more OMI-related messages is associated with one of the one or more primary layers.

Since the one or more OMI-related messages are associated with each of the one or more primary layers, an OMI-related message including information on an object mask required by an application of the decoding apparatus can be selectively acquired. Accordingly, coding efficiency of OMI-related messages can be improved, and further, transmission efficiency can also be improved.

FIG. 6 is a flowchart illustrating a method of encoding image information according to an embodiment of the present disclosure.

Terms and names (e.g., names of syntax elements, names of variables, etc.) illustrated in FIG. 6 are mere examples, and the technical features of the present disclosure are not limited by the terms etc., illustrated in FIG. 6. For example, image information illustrated in FIG. 6 may include various kinds of information according to embodiments described in the present disclosure and may include information shown in at least one of the above-described tables.

An encoding method 600 may include operations to be described below. The operations to be described below are not essential elements of the encoding method according to the embodiment, and at least some of the operations to be described below may be omitted. In addition, the operations to be described below are not sufficient elements of the encoding method according to the embodiment, and the above-described operations may be added. Further, the operations to be described below are integrated with the above-described operations into the embodiment unless they contradict the above-described operations, and do not constitute an embodiment separately from the above-described operations.

The encoding apparatus may generate an OMI-related message (610).

For example, the processor of the encoding apparatus may generate an OMI-related message on the basis of a primary layer.

The encoding apparatus may perform image analysis on a picture of the primary layer and generate information on an object region for an object detection and tracking task. In other words, the encoding apparatus may generate an object mask for an object detection and tracking task on the basis of the picture of the primary layer. In this way, since the encoding apparatus performs image analysis on the picture of the primary layer, power consumption of the decoding apparatus is reduced, and it is possible to detect and track an object more accurately. Here, the primary layer is not limited by the name and is referred to by various names such as primary picture layer or the like.

The encoding apparatus may generate an auxiliary layer associated with the primary layer on the basis of the object mask. The auxiliary layer may include the object mask for an object detection and tracking task for the primary layer. Here, the auxiliary layer is not limited by the name and is referred to by various names such as auxiliary picture layer or the like.

The encoding apparatus may generate an SEI message, that is, an OMI-related message, on the basis of information on the object mask. The OMI-related message may include the information on the object mask (hereinafter “object mask information”) of the auxiliary layer associated with the primary layer.

In particular, the encoding apparatus may generate one or more OMI-related messages associated with each of one or more primary layers. For example, the encoding apparatus may generate one or more object masks associated with each of the one or more primary layers. The encoding apparatus may generate one or more OMI-related messages including information on the one or more object masks.

Here, one of the one or more OMI-related messages may be associated with only one current primary layer among the one or more primary layers. Also, one OMI-related message may exist in one current primary layer.

The OMI-related messages may have various names, such as OMI SEI message etc., and there is no limitation on the name.

The OMI-related messages may have various forms. For example, an OMI-related message may be a syntax element or a syntax structure including one or more syntax elements. In addition, an OMI-related message may be an RBSP including one or more syntax elements or one or more syntax structures. For example, the OMI-related messages may be referred to as object_mask_info(payloadSize) etc., but are not limited thereto.

The OMI-related messages may include OMI cancellation flag information, OMI persistence flag information, primary layer identification information, auxiliary layer number information, information on an object mask, and the like.

The OMI cancellation flag information may indicate whether the persistence of a previous OMI-related message of a current OMI-related message is cancelled. For example, an OMI cancellation flag information value of 1 may indicate that the persistence of a previous OMI-related message existing in a current primary layer based on an output order is cancelled. Also, an OMI cancellation flag information value of 0 may indicate that the OMI cancellation flag information is followed by object mask information.

The OMI cancellation flag information may have various forms and may be referred to by various names. For example, the OMI cancellation flag information may be a syntax element or a syntax structure including one or more syntax elements. As an example, the OMI cancellation flag information which is a syntax element may be referred to as omi_cancel_flag etc., but is not limited thereto.

The OMI persistence flag information may indicate the persistence of object mask information included in the OMI-related messages. An OMI persistence flag information value of 1 may indicate that the object mask information included in the OMI-related messages is applied to not only a current picture but also subsequent pictures of all primary layers based on the output order. Also, an OMI persistence flag information value of 0 may indicate that the object mask information included in the OMI-related messages is applied to a current picture. However, the present disclosure is not limited thereto, and alternatively, what is specified by the OMI persistence flag information value of 1 may be exchanged with what is specified by the OMI persistence flag information value of 0.

The OMI persistence flag information may have various forms and may be referred to by various names. For example, the OMI persistence flag information may be a syntax element or a syntax structure including one or more syntax elements. As an example, the OMI persistence flag information which is a syntax element may be a persistence flag of one bit or a persistence indicator of two or more bits. OMI persistence flag information which is a syntax element may be referred to as omi_persistence_flag etc., but is not limited thereto.

The primary layer identification information may indicate identification information of a primary layer. The primary layer identification information may have various forms and may be referred to by various names. For example, the primary layer identification information may be a syntax element or a syntax structure including one or more syntax elements. As an example, the primary layer identification information which is a syntax element may be referred to as omi_primary_pic_layer_id etc., but is not limited thereto.

The auxiliary layer number information may indicate the number of auxiliary layers associated with a primary layer. The auxiliary layer number information may have various forms and may be referred to by various names. For example, the auxiliary layer number information may be a syntax element or a syntax structure including one or more syntax elements. As an example, the auxiliary layer number information which is a syntax element may be referred to as omi_num_aux_pic, omi_num_aux_pic_layer_minus1, etc., but is not limited thereto. When the auxiliary layer number information is referred to as omi_num_aux_pic_layer_minus1, a value acquired by adding 1 to the auxiliary layer number information may indicate the number of auxiliary layers associated with the primary layer.

The information on an object mask may include information indicating an object mask included in at least one auxiliary layer. For example, the information on an object mask may include information on a depth of the object mask, information on a label of the object mask, information on a position (top coordinates and left coordinates) of the object mask, information on a size (a width and height) of the object mask, and the like.

The encoding apparatus may encode image information (620).

For example, the processor of the encoding apparatus may encode image information including one or more primary layers including pictures, one or more auxiliary layers including object masks for the pictures, and one or more OMI-related messages including information on the object masks.

As described above, image information may include one or more primary layers, at least one auxiliary layer associated with the one or more primary layers, and one or more OMI-related messages associated with each of the one or more primary layers. The at least one auxiliary layer may include at least one object mask for detecting and tracking an object included in a picture in at least one primary layer.

Also, the one or more OMI-related messages may include information on the object mask associated with the one or more primary layers. Here, the one or more OMI-related messages are associated with each of the one or more primary layers. In other words, one of the one or more OMI-related messages is associated with one of the one or more primary layers.

Since the one or more OMI-related messages are associated with each of the one or more primary layers, an OMI-related message including information on an object mask required by an application of the decoding apparatus can be selectively encoded. Accordingly, coding efficiency of OMI-related messages can be improved, and further, transmission efficiency can also be improved.

A bitstream is generated on the basis of the image information encoded according to the encoding method 600 described above, and the bitstream may be stored in a computer-readable storage medium.

Also, a bitstream is generated on the basis of the image information encoded according to the encoding method 600 described above, and the bitstream may be transmitted through a transmitter and/or a transmission medium.

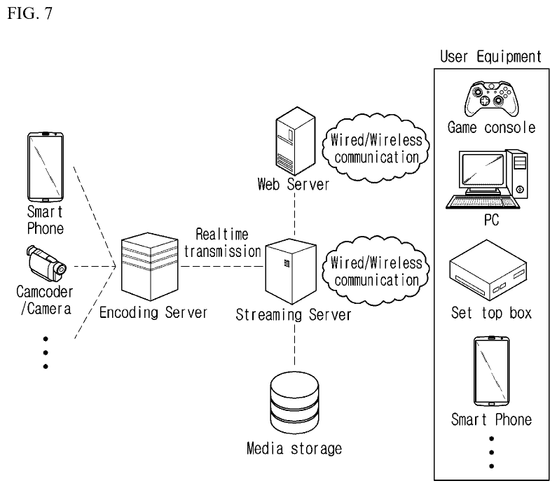

FIG. 7 is a diagram exemplifying a content streaming system to which an embodiment according to the present disclosure can be applied.

Referring to FIG. 7, the content streaming system to which the embodiment(s) of the present document is applied may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present document is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (ex. smartwatches, smart glasses, head mounted displays), digital TVs, desktops computer, digital signage, and the like.

Each server in the content streaming system may be operated as a distributed server, in which case data received from each server may be distributed.

The scope of the present disclosure includes software or machine-executable instructions (e.g., an operating system, an application, firmware, a program, etc.) that cause operations according to various embodiments of the present disclosure to be executed on a device or a computer, and a non-transitory computer-readable medium having such software or instructions stored thereon and being executable on the device or the computer.

The embodiments of the present disclosure may be used to encode or decode an image.

What is claimed is:

1. A method for decoding image information, the method comprising:
obtaining the image information including at least one primary picture layer among a plurality of layers and at least one object mask information (OMI) related message associated with the at least one primary picture layer, respectively; and
processing the at least one OMI related message,
wherein an OMI related message among the at least one OMI related message is associated with only a current primary picture layer among the at least one primary picture layer.

2. The method of claim 1, wherein the OMI related information is present in the current primary picture layer.

3. The method of claim 1, wherein the image information further includes at least one auxiliary picture layer associated with the current primary picture layer, and
wherein the OMI related message includes information on the at least one auxiliary picture layer.

4. The method of claim 3, wherein the information on the at least one auxiliary picture layer includes information on an object mask of the at least one auxiliary picture layer.

5. The method of claim 1, wherein the OMI related information further includes OMI persistence flag information indicating persistence of the object mask information of the OMI related information,
wherein object mask information of the OMI related information is applied only for a current picture based on a value of the OMI persistence flag information equal to 0, and
wherein the object mask information of the OMI related information is applied for the current picture and subsequent pictures in the current primary picture layer based on a value of the OMI persistence flag information equal to 1.

6. A method for encoding image information, the method comprising:
generating at least one object mask information (OMI) related message associated with at least one primary picture layer among a plurality of layers, respectively; and
encoding the image information including the OMI related message,
wherein an OMI related message among the at least one OMI related message is associated with only current primary picture layer among the at least one primary picture layer.

7. The method of claim 6, wherein the OMI related information is present in the current primary picture layer.

8. The method of claim 6, wherein the image information further includes at least one auxiliary layer associated with the current primary picture layer, and
wherein the OMI related message includes information on the at least one auxiliary layer.

9. The method of claim 8, wherein the information on the at least one auxiliary layer includes information on a object mask of the at least one auxiliary layer.

10. The method of claim 6, wherein the OMI related information further includes OMI persistence flag information indicating persistence of the object mask information of the OMI related information,
wherein object mask information of the OMI related information is applied only for a current picture based on a value of the OMI persistence flag information equal to 0, and
wherein the object mask information of the OMI related information is applied for the current picture and subsequent pictures in the current primary picture layer based on a value of the OMI persistence flag information equal to 1.

11. A computer-readable storage medium storing a bitstream generated by an encoding method,
the encoding method comprising:
generating at least one object mask information (OMI) related message associated with at least one primary picture layer among a plurality of layers, respectively; and
encoding the image information including the OMI related message,
wherein an OMI related message among the at least one OMI related message is associated with only current primary picture layer among the at least one primary picture layer.

12. A method for a bitstream for image information, the method comprising:
generating at least one object mask information (OMI) related message associated with at least one primary picture layer among a plurality of layers, respectively;
generating the bitstream for the image information including the at least one OMI related message; and
transmitting the bitstream,
wherein the image information further includes at least one auxiliary picture layer associated with the current primary picture layer,
wherein an OMI related message among the at least one OMI related message is associated with only current primary picture layer among the at least one primary picture layer.
